(19) United States
(12) Patent Application Publication
(10) Pub. No.: US 2017/0043411 A1
(43) Pub. Date: Feb. 16, 2017

(54) POWER CLAMPING CHUCK

(71) Applicant: Röhm GmbH, Sontheim/Brenz (DE)

(72) Inventor: Johannes Schweigardt, Sontheim (DE)

(21) Appl. No.: 15/234,160

(22) Filed: Aug. 11, 2016

(30) Foreign Application Priority Data
Aug. 11, 2015 (DE) 102015113194.3

(51) Int. Cl. B23B 31/171

(52) U.S. Cl. CPC B23B 31/1612; B23B 2260/004

(57) ABSTRACT

Some embodiments of the present disclosure relate to a clamping chuck with a chuck body, an axis of rotation, at least two clamps, a spiral ring, which is used as an adjustment stroke mechanism of the adjustment of at least two clamps and which can be actuated via a drive, and at least one clamping stroke mechanism, which can be actuated via a traction mechanism. The clamping stroke mechanism is arranged parallel to the axis of rotation in the chuck body and can be moved parallel to the axis of rotation.

### CROSS-REFERENCE TO RELATED APPLICATIONS/INCORPORATION BY REFERENCE

This patent application makes reference to, claims priority to, and claims benefit from German Patent Application No. 10 2015 113 194.3, filed on Aug. 11, 2015. The above-identified application is hereby incorporated by reference herein in its entirety.

### FIELD OF THE DISCLOSURE

Some embodiments of the present disclosure relate to a clamping chuck that includes, for example, a chuck body, an axis of rotation, at least two clamps, a spiral ring, which is used as an adjustment stroke mechanism that adjusts at least two clamps and which can be actuated via a drive, and at least one clamping stroke mechanism, which can be actuated via a traction mechanism.

### BACKGROUND

Limitations and disadvantages of conventional and traditional approaches will become apparent to one of skill in the art, through comparison of such systems with the present disclosure as set forth in the remainder of the present application with reference to the drawings.

### BRIEF SUMMARY

Systems, devices, and methods that provide a clamping chuck are provided, substantially as illustrated by and/or described in connection with at least one of the figures, as set forth more completely in the claims.

### BRIEF DESCRIPTION OF THE DRAWINGS

FIG. 1 shows a plan view of a first embodiment of a clamping chuck according to the present disclosure.

FIG. 2 shows a section II-II view from FIG. 1 of the first embodiment of the clamping chuck according to the present disclosure.

FIG. 3 shows a section III-III view from FIG. 1 of the first embodiment of the clamping chuck according to the present disclosure.

FIG. 4 shows a plan view of a second embodiment of the clamping chuck according to the present disclosure.

FIG. 5 shows a section V-V view from FIG. 4 of the second embodiment of the clamping chuck according to the present disclosure.

### DETAILED DESCRIPTION

Some embodiments of the present disclosure relate to a clamping chuck that includes, for example, a chuck body, an axis of rotation, at least two clamps, a spiral ring, and at least one clamping stroke mechanism. The spiral ring can be configured as an adjustment stroke mechanism that can be configured to adjust the at least two clamps and that can be configured to be actuated via a drive. The at least one clamping stroke mechanism can be configured to be actuated via a traction mechanism.

Some embodiments of the present disclosure provide a user friendly clamping chuck that has a fast closure capability and high clamping forces.

Some embodiments of the present disclosure provide a clamping chuck that includes a clamp that is arranged parallel to the axis of rotation in the chuck body and can be moved parallel to the axis of rotation. This arrangement makes it possible to guarantee a fast and easy presetting of the clamp via the adjustment stroke mechanism. As a result, any and all workpieces with a highly variable diameter can be clamped with the same clamping chuck. The clamping stroke mechanism, which is arranged in the chuck body parallel to the axis of rotation and can be moved parallel to the axis of rotation, makes it possible, on insertion of the workpiece, to clamp the workpiece with the maximum possible clamping force by actuating the traction mechanism. Within the context of the present disclosure, it is provided that the chuck body has an adjustment element, which can be connected to the spiral ring. The adjustment element transfers the movement of the spiral ring to the clamp, which can also be connected to the adjustment element. The clamping stroke mechanism is arranged in the chuck body parallel to the axis of rotation (e.g., perpendicular to the direction of adjustment of the adjustment element) and can be moved parallel to the axis of rotation (e.g., perpendicular to the direction of adjustment of the adjustment element). The direction of adjustment of the adjustment element is radially outwards or radially inwards. This arrangement and the direction of adjustment of the clamping stroke mechanism lead to a significant reduction in the space requirement in the chuck body and make it possible to form other structures, such as cavities which, in turn, result in a reduction in weight.

Some embodiments of the present disclosure provide that the drive can be actuated either automatically or manually. In one embodiment, the drive can be actuated automatically, and the drive is allotted a sensor that monitors the automatic pre-adjustment. Such a monitoring can be effected, for example, by determining the number of revolutions of the drive. Clamping chucks, which have a large chucking capacity, often have the drawback that in order to change the clamping diameter, the clamps have to be released by hand and shifted, an aspect that makes production time-consuming and expensive. An automatic presetting would speed up this process significantly and, in addition, make it possible to carry on production in unmanned shifts.

In some embodiments of the present disclosure, at least three clamps, which are distributed at regular intervals over the periphery of the chuck body, are provided, and each of the clamps is assigned a clamping stroke mechanism. Furthermore, it is provided that the traction mechanism can be operated hydraulically, pneumatically or electrically. In the case of a hydraulic or pneumatic actuation, it is advantageous for the traction mechanism to be designed as a piston and for a tension rod or a tension tube to be designed in the chuck body.

In some embodiments of the present disclosure, the clamping stroke mechanism includes a cone and a lock, and the lock is arranged in a guide pocket that is formed on the traction mechanism. In some embodiments, the lock is used to make sure that the clamping stroke mechanism will not fall out if the clamp is not attached to the chuck body. The lock is also used to transmit, upon actuation of the stroke mechanism, the movement of the stroke mechanism by way of the cone to the clamp. Owing to the guide pocket, which has a radial expansion, the clamping stroke mechanism is disposed in a manner allowing movement in the guide pocket. In one embodiment, the lock is formed as an end disk on the cone.

In some embodiments of the present disclosure, the chuck body has a closing plate on the side facing the clamp, and a cavity is formed in the closing plate. It is provided that the clamp and the adjustment element are disposed in a manner allowing movement in this cavity. In particular, it is provided that a part of the adjustment element is disposed in a manner allowing movement in the cavity. The formation of cavities leads to a reduction in the weight of the clamping chuck. Owing to the arrangement of the adjustment element in the cavity, the adjustment element is pushed radially inwards or outwards via the spiral ring when the drive is actuated, with the result that it is possible to perform a presetting of the desired chucking capacity.

Some embodiments of the present disclosure provide an adjustment element pocket that is formed in the chuck body and at least one part of the adjustment element that is disposed in a manner allowing movement in the adjustment element pocket. This arrangement leads to an additional reduction in weight. It is also provided that, on actuation of the drive, the adjustment element and, with the adjustment element, the clamping stroke mechanism and the clamp can be moved radially outwards or inwards. In some embodiments, at least the clamping stroke mechanism and the adjustment element can be moved in the adjustment element pocket, the cavity, and the guide pocket. In this context, the radial expansion of the adjustment element pocket corresponds to at least the radial expansion of the guide pocket. This allows the clamping stroke mechanism and the adjustment element to be displaced in parallel. Depending on the diameter of the end disk of the clamping stroke mechanism, it is also possible for the expansion of the adjustment element pocket to be larger or smaller than the radial expansion of the guide pocket.

Some embodiments of the present disclosure provide that the closing plate is assigned a locking plate and that a locking receptacle, with which the locking plate engages, is formed in the clamp or the adjustment element. This arrangement is used to secure the adjustment element or the clamp against an undesired release and is used to guide the same when displaced by the drive or the traction mechanism.

Some embodiments of the present disclosure provide that the clamp is formed as a clamping jaw or as a face clamping finger. In some embodiments, the design of the clamping stroke mechanism, assigned to the clamp, and the design of the adjustment element are adapted to the design of the clamp. Furthermore, it is advantageous if the adjustment element is formed as an adjustment jaw.

Some embodiments of the present disclosure provide that the clamping stroke mechanism, assigned to the clamping jaw, is formed as a clamping claw, which has a wedge that is disposed in a wedge receptacle, formed in the clamping jaw. In some embodiments, the actuation of the clamping claw leads to an adjustment of the wedge inside the wedge receptacle. As a result, the clamping jaws are adjusted radially inwards or outwards in order to clamp the workpiece.

Some embodiments of the present disclosure provide that each clamping jaw is assigned an adjustment element receptacle, which is formed in the adjustment element and in which at least one part of the clamping claw is received. This arrangement makes possible a particularly space-saving possibility of integrating the adjustment stroke mechanism (e.g., the spiral ring), the adjustment element and the clamping stroke mechanism (e.g., a clamping claw) in a chuck body and, in so doing, achieving a large chucking capacity and a high clamping force.

Some embodiments of the present disclosure provide that the clamping stroke mechanism, which is assigned to the face clamping finger, is formed as a pin and that the pin can be connected to the face clamping finger. In some embodiments, the pin can be formed as a screw or as a rivet. On actuation of the traction mechanism, the force is transferred via the pin to the face clamping finger, which is then pushed axially in such a way that the workpiece is clamped.

Some embodiments of the present disclosure provide that each face clamping finger is assigned an adjustment element receptacle, which is formed in the adjustment element and in which the face clamping finger and the pin are at least partially received. This arrangement also leads to a space-saving possibility of integrating the adjustment stroke mechanism (e.g., the spiral ring), the adjustment element and the clamping stroke mechanism (e.g., the pin) in a chuck body with simultaneously large chucking capacity and high clamping force.

Some embodiments of the present disclosure provide an adjustment element thread that is formed on the side of the adjustment element that faces away from the clamp in such a way that the adjustment element thread lies radially outwards. In some embodiments, the adjustment element thread makes it possible to adjust the clamp radially outwards or inwards. Furthermore, in this context it has proved to be advantageous that the drive is disposed radially on the chuck body and has a gear teeth system, which meshes with the gear teeth system of the spiral ring in order to transfer the force to the spiral ring. This arrangement makes possible a space-saving and effective possibility of actuating the spiral ring or, more specifically, the adjustment element. In addition, the drive can be actuated either automatically or manually. In one embodiment, the gear teeth system is formed as a bevel gear teeth system.

In summary, some embodiments of the clamping chuck of the present disclosure can provide a clamping chuck with a large chucking capacity. Furthermore, the arrangement of the clamping stroke mechanism in an adjustment element receptacle of the adjustment element creates a space-saving and effective possibility of pre-adjusting the clamp and clamping the clamp.

Owing to this arrangement, there is space inside the clamping chuck for other structures, such as the cavity, the guide pocket and the adjustment element pocket, which makes possible a wide adjustment stroke (e.g., a high chucking capacity), and which contributes simultaneously to the reduction in weight of the chuck body. The drive, which is formed radially on the chuck body, allows the spiral ring to be actuated not only manually, but also automatically. In the case of an automatic actuation of the spiral ring or an automatic pre-adjustment of the clamp, it is possible to lower the production costs and to carry on production or, more specifically, to clamp in unmanned shifts. Moreover, some embodiments of the clamping chuck according to the present disclosure are not restricted to an actuation of the traction mechanism, but rather can also be operated hydraulically, pneumatically or electrically.

Some embodiments of the present disclosure are explained in greater detail below by reference to two embodiments that are shown in the drawings solely for illustrative purposes.

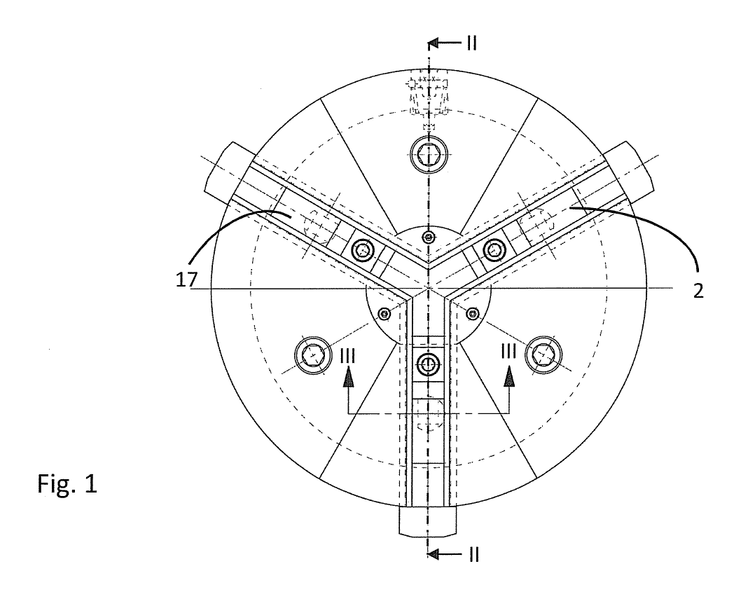

FIG. 1 shows a first embodiment of a clamping chuck according to the present disclosure. The clamping chuck includes three clamps 2, which are distributed at regular intervals over the periphery, in the form of clamping jaws 17.

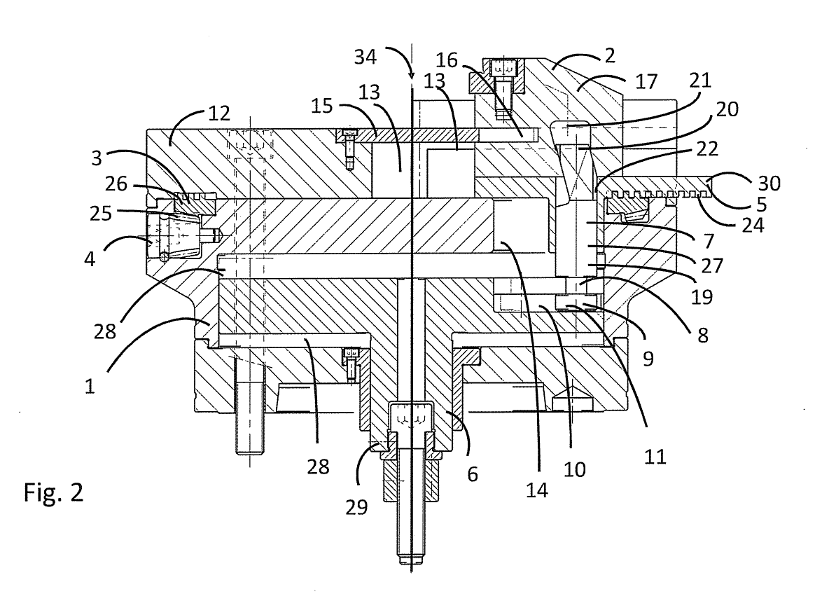

FIG. 2 is a longitudinal view of the first embodiment of the clamping chuck, by means of which the functional design of the clamping chuck will be explained below. Referring to FIG. 2, the clamping chuck has a chuck body 1, in which a spiral ring 26, which can be actuated via a drive 4 that is formed radially on the chuck body 1, is formed. This spiral ring 26 is used as an adjustment stroke mechanism 3 of the pre-adjustment of the adjustment element 5 and the clamping jaws 17. The drive 4 can be actuated either automatically or manually and has a gear teeth system 25, which meshes with the gear teeth system 25 of the spiral ring 26 in order to transfer the force to the spiral ring 26. An adjustment element thread 24, which in turn interacts with the spiral spring 26, is formed on the bottom side of the adjustment element 5 in such a way that the adjustment element thread lies radially outwards. The adjustment element 5 is formed as an adjustment jaw and has an adjustment element receptacle 22, which closes cylindrically around the clamping stroke mechanism 7. The clamping stroke mechanism 7 is formed as a clamping claw 19, which has a lock 9, a cone 8, a clamping stroke mechanism body 27 and a wedge 20, which is disposed in a wedge receptacle 21, which is formed in the clamping jaw 17. The clamping claw 19 is arranged parallel to the axis of rotation 34 (e.g., perpendicular to the direction of adjustment of the adjustment element 5) in the chuck body 1 and can be moved parallel to the axis of rotation 34 (e.g., perpendicular to the direction of adjustment of the adjustment element 5) in the adjustment element receptacle 22 and in the wedge receptacle 21. Furthermore, the chuck body 1 has a closing plate 12 on the side facing the clamping jaws 17, where a cavity 13 is formed in the closing plate 12. Furthermore, an adjustment element pocket 14 and a traction mechanism receptacle 28, in which the traction mechanism 6 is disposed, are formed in the chuck body 1. The traction mechanism 6 is formed as a piston 29 with a traction tube. In the piston, there is in turn a guide pocket 10, which has a radial expansion, in which the lock 9, formed as an end disk 11, is disposed. The adjustment element plate 30 and parts of the clamping jaws 17 are arranged in a manner allowing movement in the cavity 13. In addition, the closing plate 12 has a locking plate 15, which engages with a locking receptacle 16 that is formed on the clamping jaws 17. The adjustment element receptacle 22 is arranged with the clamping stroke mechanism body 27 in a manner allowing movement in the adjustment element pocket 14.

In order to preset the clamping diameter, the drive 4 is actuated, with the effect that the adjustment element 5 is moved via the spiral ring 26 radially outwards or inwards inside the cavity 13. The clamping claw 19 moves with the adjustment element 5, with the result that the movement of the adjustment element 5 is transferred via the wedge 20 of the clamping claw 19 to the clamping jaws 17. The adjustment element 5 and the clamping claw 19 can be moved inside the adjustment element pocket 14, the traction mechanism receptacle 28 and the guide pocket 10. The movement of the clamping jaws 17 is also guided in that the locking plate 15 moves inside the locking receptacle 16 of the clamping jaws 17. After the presetting of the clamping jaws 17, the workpiece is inserted (e.g., inserted manually or automatically), and the workpiece is clamped by pulling or pushing the piston 29 with the traction tube, depending on whether external clamping or internal clamping is provided, in the direction of the clamping jaws 17 or in the direction away from the clamping jaws 17. The movement of the piston 29 is transferred by way of the lock 9 of the clamping claw 19 to the wedge 20, which moves inside the wedge receptacle 21 of the clamping jaw 17. The asymmetrical form of the wedge receptacle 21 leads to a radial adjustment of the clamping jaws 17 in the outward or inward direction. The piston 29 can be operated pneumatically, hydraulically or electrically.

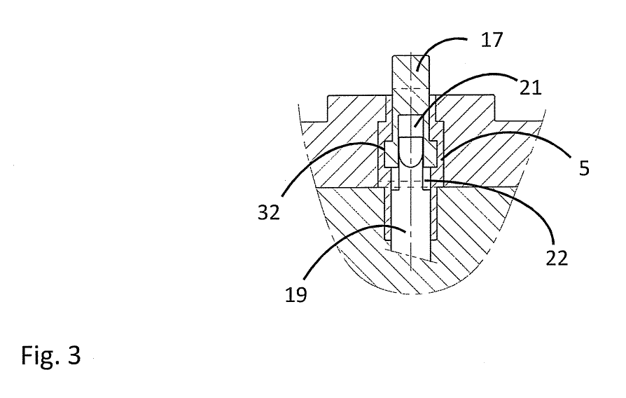

FIG. 3 shows a cross section, in which the arrangement of the clamping claw 19 inside the chuck body 1 and its interaction with the clamping jaw 17 and the adjustment element 5 are explained. Referring to FIG. 3, the clamping claw 19 can be moved inside the adjustment element receptacle 22, and the adjustment element receptacle 22 not only receives the clamping claw 19, but also a part of the clamping jaw 17. The adjustment element 5 has receptacles 32, with which the clamping jaw 17 engages and, as a result, is used as a guide groove to receive the clamping jaw 17 and to additionally secure the clamping jaws 17.

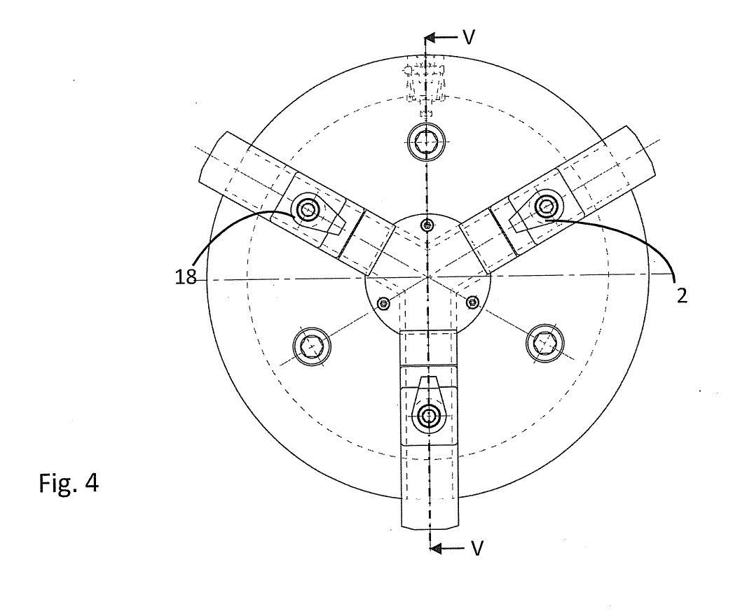

FIG. 4 is a plan view of a second embodiment of the clamping chuck according to the present disclosure. Referring to FIG. 4, the claiming chuck has three face clamping fingers 18, which are uniformly distributed over the periphery, as the clamps 2.

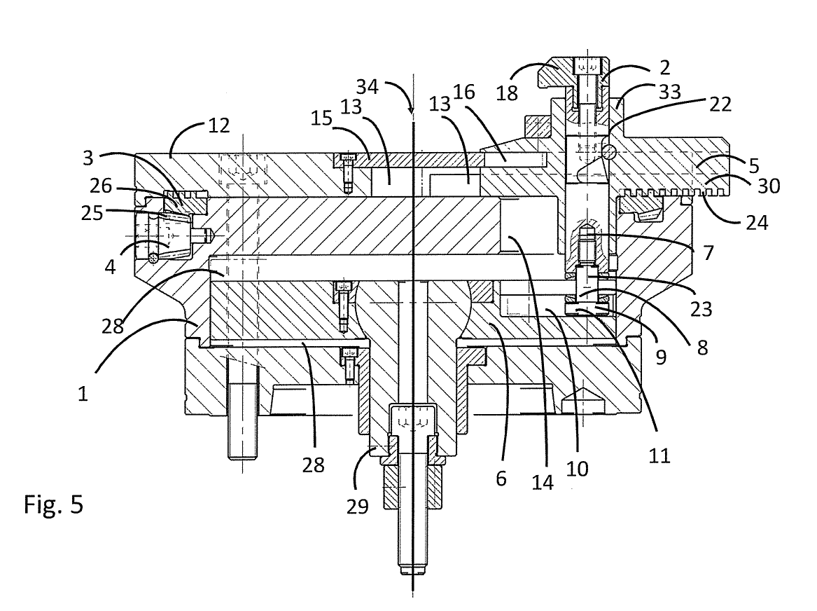

FIG. 5 is a longitudinal view of the second embodiment of the clamping chuck according to the present disclosure that is constructed in a manner similar to that of the first embodiment. Referring to FIG. 5, the clamping stroke mechanism 7 is formed as a pin 23, which is connected to the face clamping finger 18. The locking receptacle 16 is not formed on the clamp 2, but rather is formed on the adjustment element 5. The adjustment element plate 30 is arranged in a manner allowing movement in the cavity 13. The adjustment element 5 has an adjustment element top 33 on the side assigned to the clamp 2, and an adjustment element receptacle 22, in which the face clamping finger 18 and the associated pin 23 are moveably disposed.

The presetting is performed by actuating the drive 4, which is arranged radially on the chuck body 1 and which causes a radial pre-adjustment of the adjustment element 5 via the spiral ring 26 in the outward or inward direction. Owing to the arrangement of the face clamping fingers 18 inside the adjustment element receptacle 22, the face clamping fingers 18 are adjusted radially outwards or inwards, so that together with the adjustment element 5, the pin 23 is moved radially outwards or inwards inside the guide pocket 10, the traction mechanism receptacle 28 and with the adjustment element 5 in the adjustment element pocket 14. After the presetting, which can be done manually or automatically, has been completed, the workpiece is inserted and clamped by moving the piston 29 via the tension rod in the direction of the face clamping finger 18 or opposite the direction of the face clamping finger 18. In contrast to the first embodiment, the clamping movement of the face clamping finger 18 takes place perpendicular to the adjustment movement of the adjustment element 5.

List of Reference Numerals

| | |
|---|---|
| 1 | chuck body |
| 2 | clamp |
| 3 | adjustment stroke mechanism |
| 4 | drive |
| 5 | adjustment element |
| 6 | traction mechanism |
| 7 | clamping stroke mechanism |
| 8 | cone |
| 9 | lock |
| 10 | guide pocket |
| 11 | end disk |
| 12 | closing plate |
| 13 | cavity |
| 14 | adjustment element pocket |
| 15 | locking plate |
| 16 | locking receptacle |
| 17 | clamping jaw |
| 18 | face clamping finger |
| 19 | clamping claw |
| 20 | wedge |
| 21 | wedge receptacle |
| 22 | adjustment element receptacle |
| 23 | pin |
| 24 | adjustment element thread |
| 25 | gear teeth system |
| 26 | spiral ring |
| 27 | clamping stroke mechanism body |
| 28 | traction mechanism receptacle |
| 29 | piston |
| 30 | adjustment element plate |
| 31 | guide surfaces |
| 32 | receptacle |
| 33 | adjustment element top |
| 34 | axis of rotation |

What is claim is:

1. A clamping chuck, comprising:
a chuck body;
at least two clamps;
a spiral ring configured to adjust a stroke of the at least two clamps and to be actuated by a drive; and
at least one clamping stroke mechanism that can be actuated via a traction mechanism, wherein the at least one clamping stroke mechanism is arranged in parallel to an axis of rotation in the chuck body and can be moved parallel to the axis of rotation.

2. The clamping chuck according to claim 1, wherein the chuck body includes an adjustment element this is coupled to the spiral ring.

3. The clamping chuck according to claim 1, wherein the clamping stroke mechanism includes a cone and a lock, and the lock is arranged in a guide pocket that is formed on the traction mechanism.

4. The clamping chuck according to claim 3, wherein the lock is formed on the cone as an end disk.

5. The clamping chuck according to claim 1, wherein the chuck body has a closing plate on a side facing the clamps, and a cavity is formed in the closing plate.

6. The clamping chuck according to claim 2, wherein an adjustment element pocket is formed in the chuck body, and at least one part of the adjustment element is disposed in a manner allowing movement in the adjustment element pocket.

7. The clamping chuck according to claim 6, wherein a radial expansion of the adjustment element pocket corresponds to at least the radial expansion of the guide pocket.

8. The clamping chuck according to claim 5, wherein:
the closing plate is assigned a locking plate,
a locking receptacle, with which the locking plate engages, is formed in the clamps or an adjustment element, and
the adjustment element is part of the chuck body and is coupled to the spiral ring.

9. The clamping chuck according to claim 1, wherein at least one of the two clamps is formed as a clamping jaw or a face clamping finger.

10. The clamping chuck according to claim 9, wherein the clamping stroke mechanism, assigned to the clamping jaw, is formed as a clamping claw, which has a wedge that is disposed in a wedge receptacle, formed in the clamping jaw.

11. The clamping chuck according to claim 10, wherein the clamping jaw is assigned to an adjustment element receptacle, which is formed in the adjustment element and in which at a portion of the clamping claw is received.

12. The clamping chuck according to claim 9, wherein the clamping stroke mechanism, assigned to the face clamping finger, is formed as a pin, which can be connected to the face clamping finger.

13. The clamping chuck according to claim 12, wherein the face clamping finger is assigned to an adjustment element receptacle, which is formed in the adjustment element and in which the face clamping finger and the pin are at least partially received.

14. The clamping chuck according to claim 2, wherein an adjustment element thread is formed and disposed radially outwards on a side of the adjustment element that faces away from the clamps.

15. The clamping chuck according to claim 1, wherein the drive is disposed radially on the chuck body and includes a first gear teeth system that is configured to mesh with a second gear teeth system of the spiral ring to transfer a force to the spiral ring.
